(19) United States
(12) Patent Application Publication
(10) Pub. No.: US 2015/0164262 A1
(43) Pub. Date: Jun. 18, 2015

(54) BEVERAGE PREPARATION MACHINE

(71) Applicant: Kraft Foods R&D, Inc., Deerfield, IL (US)

(72) Inventors: Rebecca Dingle, Thundersley (GB); Oliver Masters, Glastonbury (GB)

(73) Assignee: Kraft Foods R&D, Inc., Deerfield, IL (US)

(21) Appl. No.: 14/372,208

(22) PCT Filed: Jan. 29, 2013
(86) PCT No.: PCT/IB2013/000220

§ 371 Date: Jul. 14, 2014

(30) Foreign Application Priority Data
Feb. 2, 2012 (GB) 1201840.4

(51) Int. Cl. A47J 31/40; B25B 5/16

(52) U.S. Cl. CPC A47J 31/407; B25B 5/16

(57) ABSTRACT

A clamping mechanism for a beverage cartridge is provided, comprising: a frame; a tray suitable for receiving a beverage cartridge therein; a clamp; and an actuator. The tray is coupled to the frame to allow the tray to move between a brewing position and a loading position. The actuator is pivotably connected to the clamp and the clamp is pivotably connected to the frame to allow the clamp to be pivoted between a clamped position and an unclamped position on rotation of the actuator relative to the frame. The tray is engagable with the clamp during movement of the tray into the loading position to move the clamp from the unclamped position to a raised position.

The present disclosure relates to beverage preparation machines and, in particular, to clamping mechanisms and methods of such beverage preparation machines.

Beverage preparation machines which produce beverages through contact of an aqueous medium with one or more beverage ingredients are known for the production of beverages such as coffee, hot chocolate and other soft drinks. An example of one such machine is disclosed in EP 1 440 910 which uses sealed beverage cartridges containing beverage ingredients. In use the beverage cartridge is inserted into a rearwardly-inclined pivotable cartridge mount of the beverage preparation machine, clamped and an inlet and outlet are formed in a sealing laminate of the beverage cartridge to allow entry of heated water and discharge of the formed beverage. The clamping of the beverage cartridge requires the closure of a cartridge head by rotating downwardly an upper part against a fixed lower part to clamp the beverage cartridge and pivotable cartridge mount therebetween.

The present disclosure relates to an alternative clamping mechanism and method in which a different mechanism for inserting and removing the beverage cartridge from the clamping mechanism is provided.

Accordingly, in one aspect there is provided a clamping mechanism for a beverage cartridge comprising:

a frame;

a tray suitable for receiving a beverage cartridge therein;

a clamp; and

an actuator;

wherein the tray is coupled to the frame to allow the tray to move between a brewing position and a loading position;

wherein the actuator is pivotably connected to the clamp and the clamp is pivotably connected to the frame to allow the clamp to be pivoted between a clamped position and an unclamped position on rotation of the actuator relative to the frame;

wherein the tray is engagable with the clamp during movement of the tray into the loading position to move the clamp from the unclamped position to a raised position.

Advantageously, the clamping mechanism of the present disclosure enables movement of the clamp from the unclamped position to the raised position as the tray is moved into the loading position. This advantageously allows a greater clearance between the clamp and the frame and/or tray when the clamping mechanism is in a loading configuration. This may help to enable the beverage cartridge to be more easily inserted during movement of the tray from the loading position into the brewing position because the clamp is preferably retained in the raised position until the point where part or a whole of the beverage cartridge has passed underneath the front edge of the clamp.

In addition, the pivotal movement of the clamp between unclamped and clamped positions allows an inlet aperture and outlet aperture to be pierced sequentially in a received beverage cartridge. For example, where an inlet piercer is provided closer to the pivot axis of the clamp than the position of an outlet piercer then the inlet aperture may be formed first.

Preferably the tray is slidably movable between the loading position and an intermediate position and further pivotably movable from the intermediate position into the brewing position.

Advantageously, the tray being slidable movable into the intermediate position allows for a straight forward movement by the user to move the tray the majority of the way into the brewed position. Thereafter pivoting of the tray into the brewing position allows for a definite and secure seating of the tray into the brewing position.

The tray may be manually slidably movable between the loading position and the intermediate position.

Similarly the tray may be manually movable from the intermediate position into the brewing position by pressing ‘down’ on a front of the tray.

Manual operation of the tray allows for a simple, low-cost clamping mechanism which is straight-forward to use. Advantageously, the clamping mechanism also lends itself to be adapted to be partly or wholly moved mechanically by means of a suitable mechanized movement of the actuator.

Preferably the tray is slidably coupled to the frame. Typically, a beverage cartridge used in the clamping mechanism will be dispensed at a pressure above atmospheric. On unclamping the beverage cartridge by rotating the actuator arms any built-up pressure will start to be vented. If necessary venting continues as the tray is slid relative to the frame. The distance between the brewing position and the loading position ensures that by the time the tray reaches the loading position the beverage cartridge will have fully vented and thus will be ready to be unloaded.

The frame may comprise a pair of guide slots and the tray may comprise first and second pairs of guide pegs slidably received in the guide slots.

In which case, the first and second pairs of guide pegs may be slidable along the pair of guide slots during movement of the tray between the loading position and the intermediate position and wherein the tray may be pivotably movable about the first pair of guide pegs during movement of the tray between the intermediate position and the brewing position.

Each guide slot may comprise a substantially, linear portion and a downwardly-angled end portion such that on movement of the tray into the loading position at least one of the first and second pairs of guide pegs may enter the downwardly-angled end portion to enable the tray to be declined to facilitate access to a beverage cartridge received therein. Preferably the downwardly-angled end portion is a front end portion of each guide slot. The downwardly-angled end portion may be angled at between 10 and 60 degrees, more preferably at 45 degrees below horizontal (assuming the frame is horizontal).

By enabling the tray to be declined in the loading position, the tray is proffered to a user providing a clear visual indication of where to insert the beverage cartridge (during a loading operation) or that the beverage cartridge is ready to be removed (during an ejection operation).

Each guide slot may further comprise a perpendicular portion at or towards a rear of each guide slot which is angled at 90 degrees to the substantially linear portion. Preferably the perpendicular portion is angled upwards relative to the substantially linear portion. Movement of the tray into the intermediate position results in the rearmost pair of the guide pegs reaching the rearmost point of the substantially linear section directly underneath the perpendicular portion. Pressing down on the front of the tray then causes the rearmost pair of guide pegs to move up along the perpendicular portion as the tray pivots about the frontmost pair of guide pegs.

The actuator may comprise a cam slot and the frame may comprise a fixed cam peg; the cam peg being engagable in the cam slot to move along said cam slot on rotation of the actuator. The cam slot is preferably shaped so that movement of the cam peg along the cam slot causes the clamp to move between its clamped and unclamped positions. Preferably the cam slot is open-ended such that the actuator may be disengaged from the fixed cam peg for a portion of its travel. In this case the actuator is preferably disengaged from the fixed cam peg when the clamp is moved from its unclamped position into its raised position.

A portion of the tray may define a cam surface and a portion of the clamp may define a follower surface, such that on movement of the tray into the loading position relative sliding contact between the cam surface and the follower surface enables the clamp to be rotated into the raised position. Advantageously, this provides a reliable means for raising the clamp at the correct point of the tray's travel.

The tray may comprise a body defining a receptacle for receiving a beverage cartridge and a pair of arms; wherein the clamp may comprise a body and a pair of arms; wherein an upper surface of the arms of the tray may define the cam surface and a lower surface of the arms of the clamp may define the follower surface.

Preferably the clamping mechanism is substantially symmetrical about its midline resulting in it comprising two guide slots, two sets of guide pegs, two side walls to the frame, two actuators, etc. This helps prevent any lateral torques being applied to the frame during operation of the clamping mechanism.

An inlet piercer and/or outlet piercer for forming an inlet and/or outlet in a beverage cartridge may be received within the tray. The piercers may be moulded as part of the tray or may be coupled to the tray by a known means such as a snap fit or ultrasonic weld.

The present disclosure also provides & beverage preparation system comprising a beverage preparation machine and a beverage cartridge, wherein the beverage preparation machine comprises a clamping mechanism as described above.

Typically, the clamping mechanism will be located such that in the loading position of the tray the tray is projected forwards relative to a remainder of the beverage preparation machine towards the location of the user. In such an arrangement the tray can be regarded as being moved ‘forwards’ into the loading position and moved ‘backwards’ into the intermediate and brewing positions.

The beverage cartridge may comprise a cup-shaped body and a substantially planar lid sealing the cup-shaped body, the beverage cartridge may contain one or more beverage ingredients, wherein the beverage cartridge may be shaped to be received in the tray of the clamping mechanism with the lid lowermost, rotation of the clamp into the clamped position being effective to pierce the lid.

The present disclosure also provides a method of clamping a beverage cartridge in a clamping mechanism of the type comprising a frame, a tray, a clamp and an actuator; comprising the steps of

a) moving the tray outwards relative to the frame into a loading position causing simultaneously the clamp to be pivoted into a raised position;

b) inserting the beverage cartridge into the tray;

c) manually sliding the tray inwards relative to the frame simultaneously causing the clamp to pivot downwards into an unclamped position;

d) rotating the actuator to move the clamp into a clamped position in which the beverage cartridge is clamped ready for brewing.

The method may further comprise between steps c) and d) the step of manually pivoting the tray relative to the frame to move the tray into a brewing position.

Aspects of the present disclosure will now be described, by way of example only, with reference to the accompanying drawings, in which;

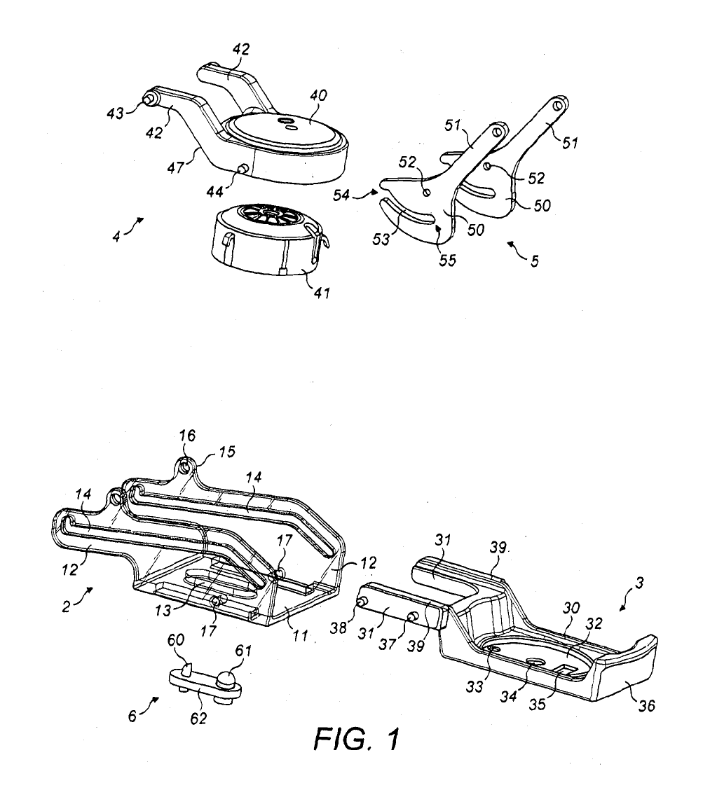

FIG. 1 is an exploded perspective view of a clamping mechanism according to the present disclosure;

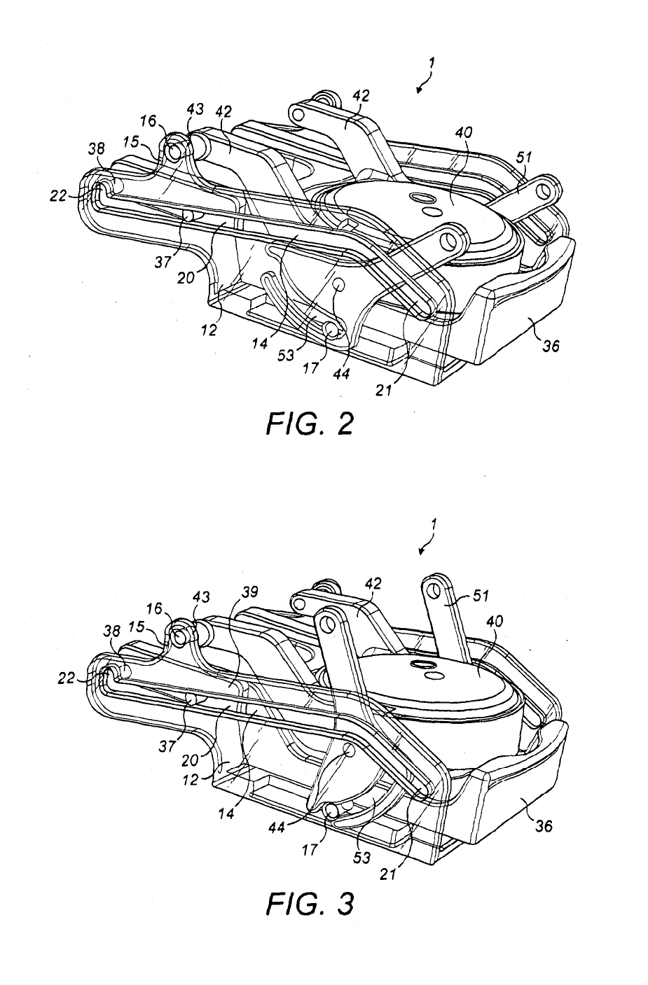

FIG. 2 is a perspective view of the clamping mechanism in an initial position with a tray of the clamping mechanism in a brewing position and a clamp of the clamping mechanism in a clamped position;

FIG. 3 is a perspective view of the clamping mechanism with the tray in the brewing position and the clamp in an unclamped position;

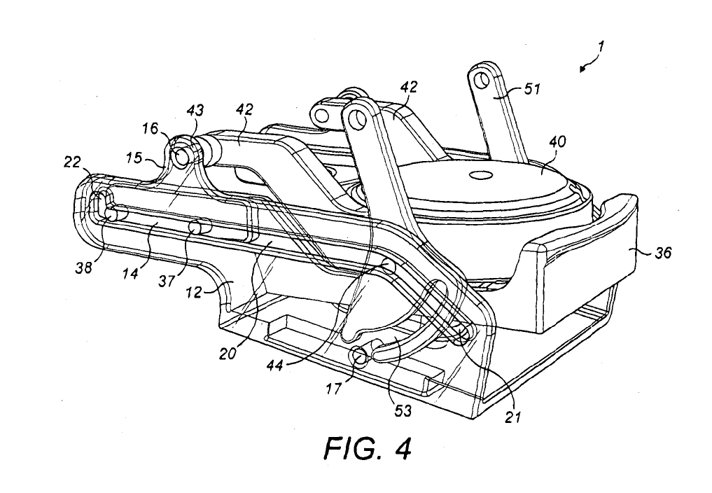

FIG. 4 is a perspective view of the clamping mechanism with the tray in an intermediate position and the clamp in an unclamped position;

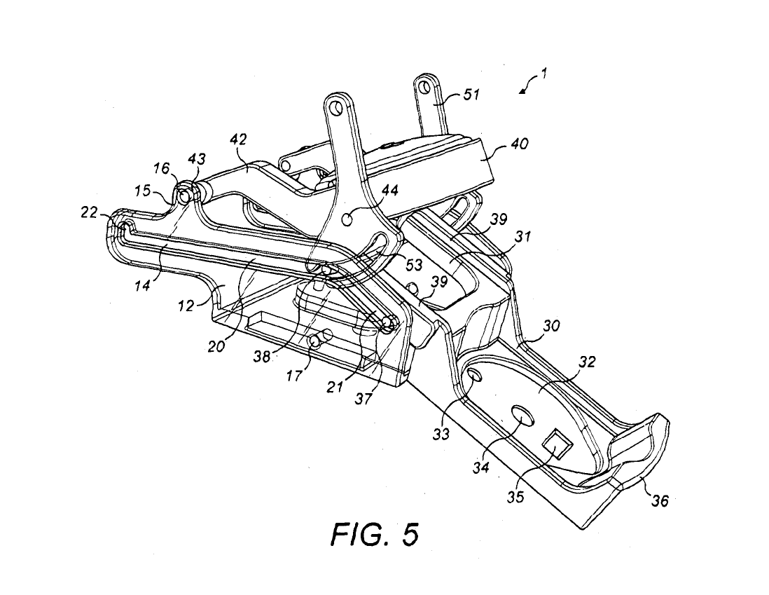

FIG. 5 is a perspective view of the clamping mechanism with the tray in a loading position and the clamp in a raised position;

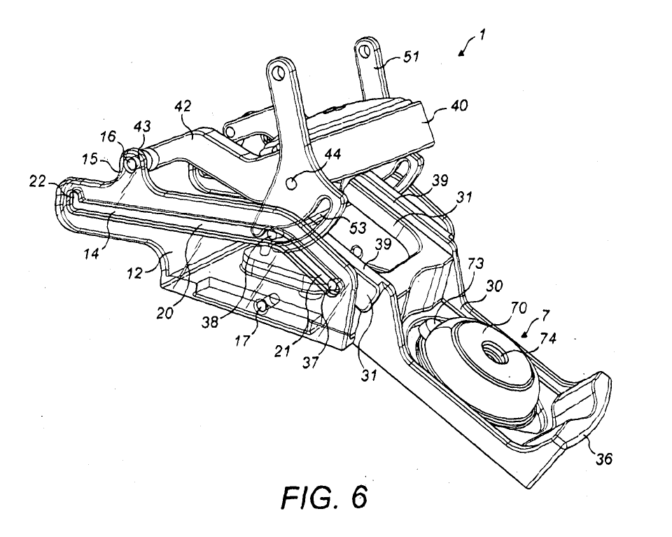

FIG. 6 is a perspective view of the clamping mechanism of FIG. 5 with a beverage cartridge received in the tray;

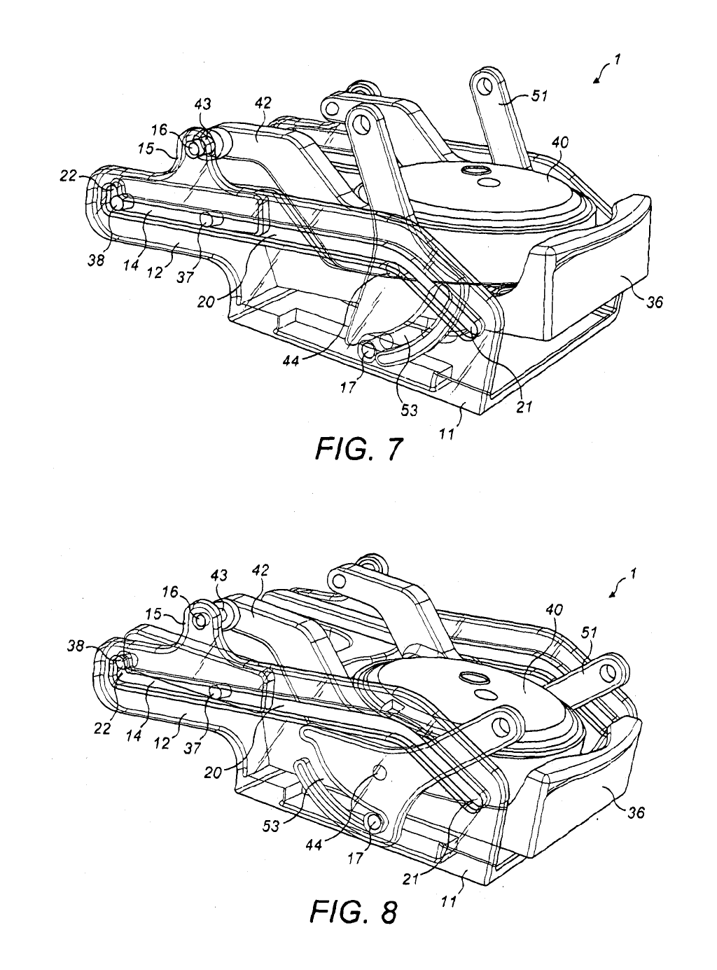

FIG. 7 is a perspective view of the clamping mechanism with the beverage cartridge loaded with the tray in an intermediate position and the clamp in an unclamped position;

FIG. 8 is a perspective view of the clamping mechanism of FIG. 7 with the tray having been moved into the brewing position and with the clamp in the clamped position;

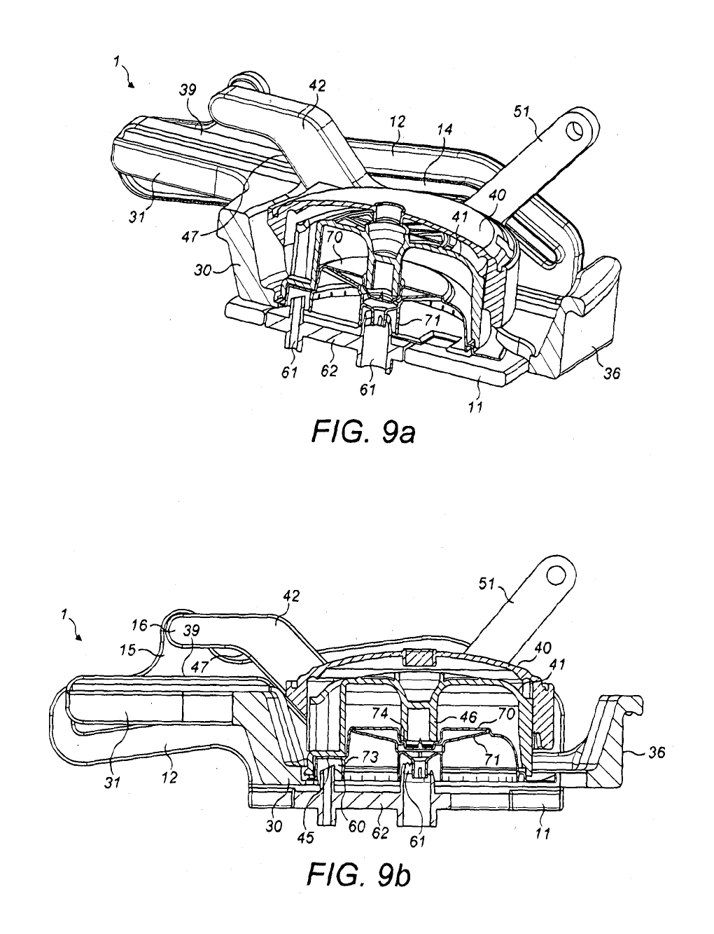

FIG. 9a is a perspective cross-sectional view of the clamping mechanism of FIG. 8;

FIG. 9b is a side elevation cross-section of the clamping mechanism of FIG. 8;

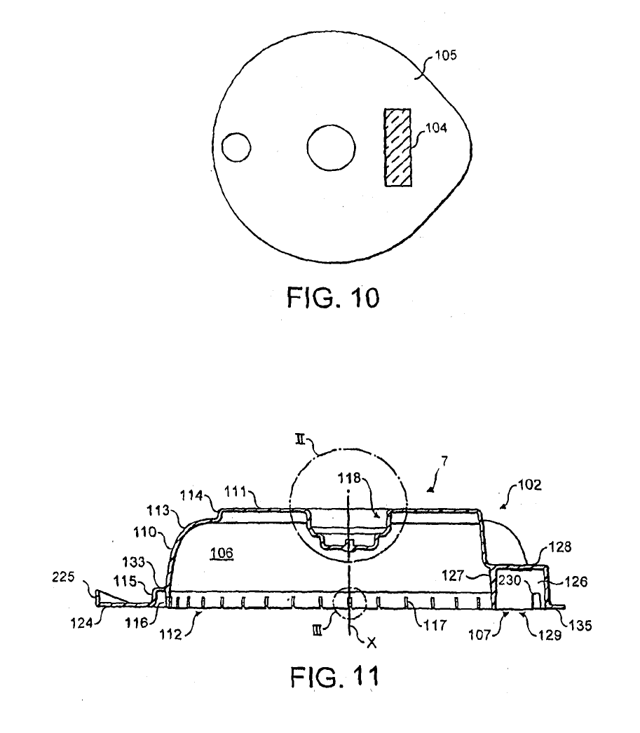

FIG. 10 is an underside plan view of a beverage cartridge for use in the clamping mechanism of the present disclosure;

FIG. 11 is a cross-sectional view of an outer member of the beverage cartridge of FIG. 10;

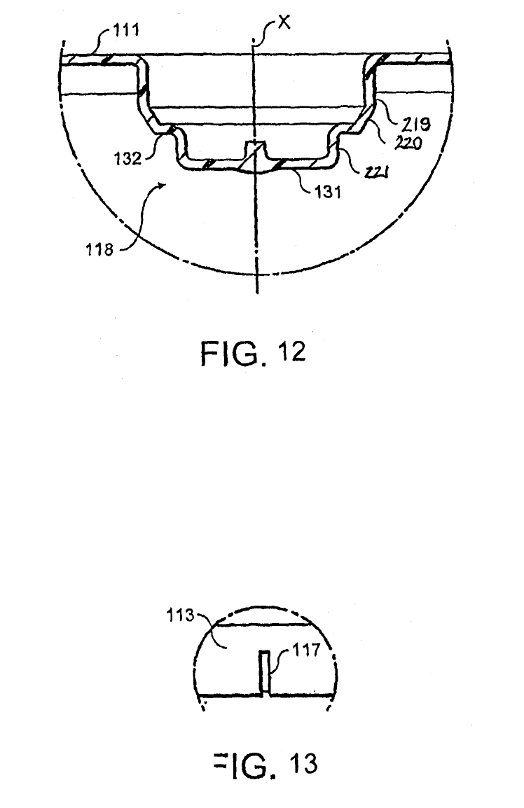

FIG. 12 is an enlarged cross-sectional view of a portion of FIG. 11 referenced II in FIG. 11;

FIG. 13 is an enlarged cross-sectional view of a portion of FIG. 11 referenced III in FIG. 11;

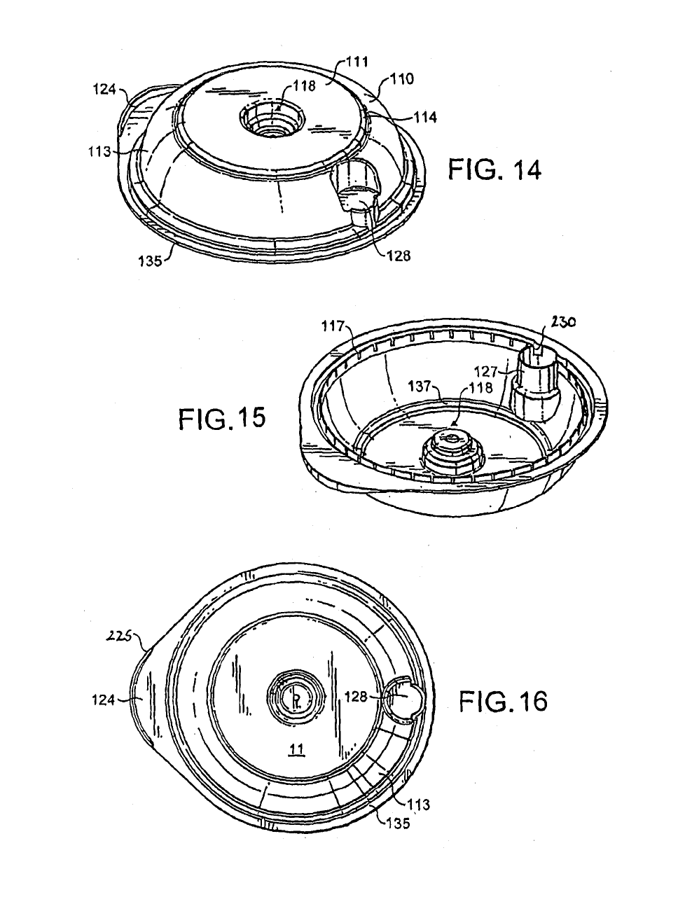

FIG. 14 is a perspective view from above of the outer member of FIG. 11;

FIG. 15 is a perspective view from underneath of the outer member of FIG. 11;

FIG. 16 is a plan view from above of the outer member of FIG. 11;

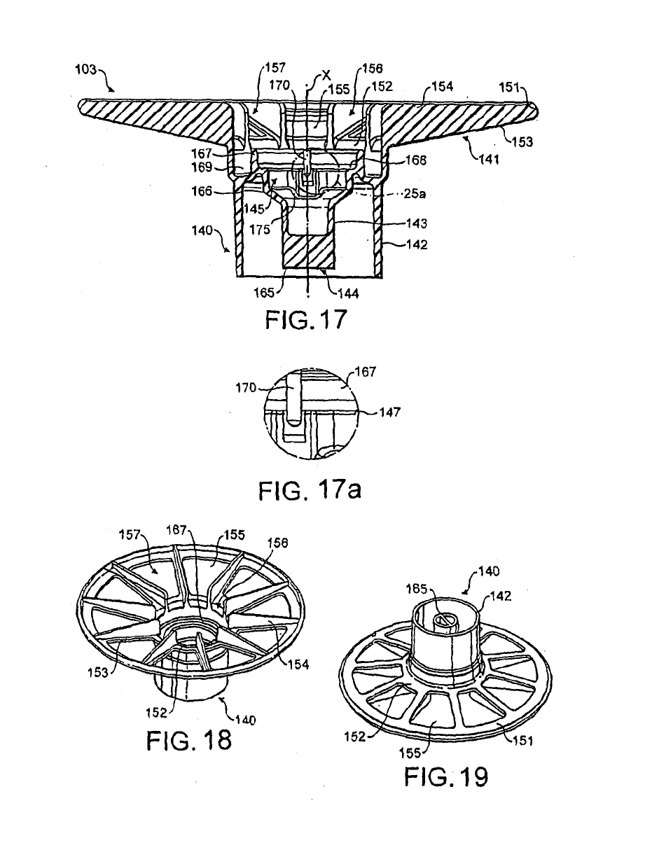

FIG. 17 is a cross-sectional view of an inner member of the beverage cartridge of FIG. 10;

FIG. 17a is an enlarged cross-sectional view of a portion of the inner member of FIG. 17 referenced 25a in FIG. 17;

FIG. 18 is a perspective view from above of the inner member of FIG. 17;

FIG. 19 is a perspective view from underneath of the inner member of FIG. 17;

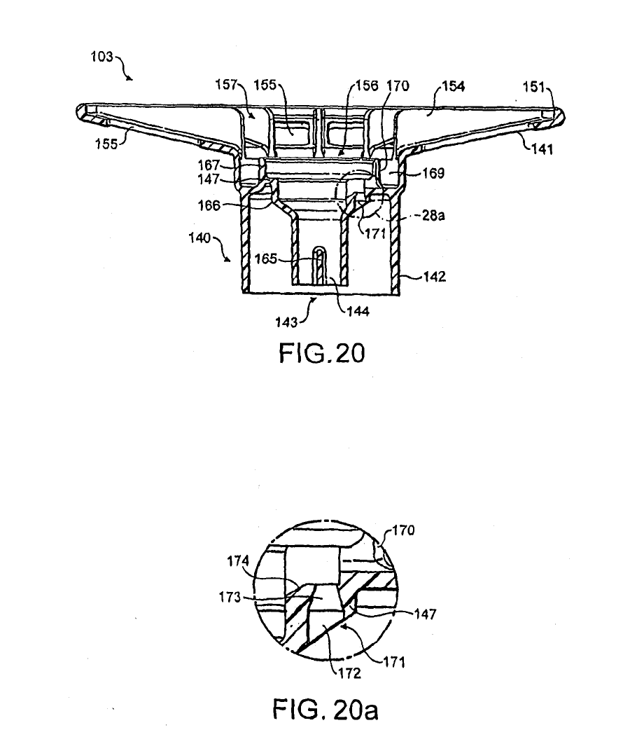

FIG. 20 is another cross-sectional view of the inner member of FIG. 17 sectioned at 90° to the section of FIG. 17;

FIG. 20a is an enlarged cross-sectional view of a portion of the inner member of FIG. 20 referenced 28a;

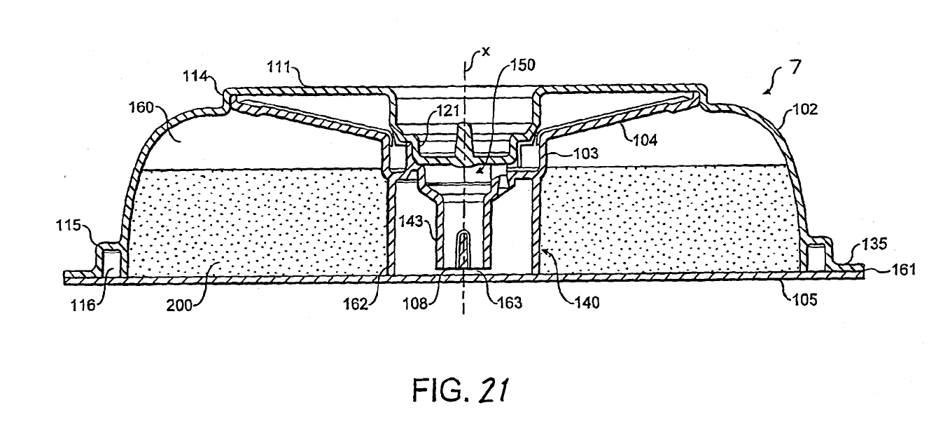

FIG. 21 is a cross-sectional view of the beverage cartridge of FIG. 10; and

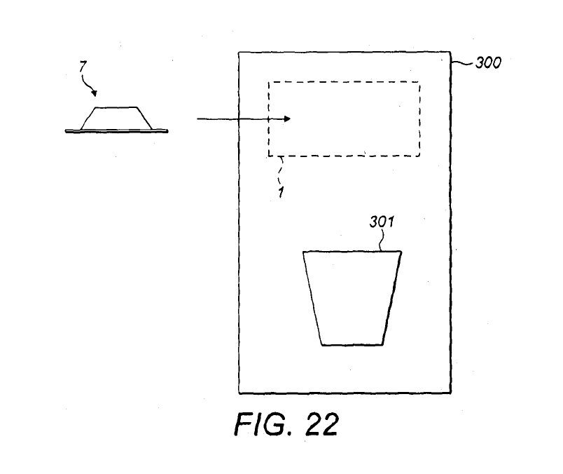

FIG. 22 is a schematic representation of a beverage preparation system according to the present disclosure.

As shown in FIG. 1, the clamping mechanism 1 of the present disclosure comprises a frame 2, a tray 3, a clamp 4, an actuator 5 and a piercer unit 6.

The frame 2 comprises a horizontal base 11 having upstanding from each lateral edge a side wall 12. The base is provided with an elongated aperture 13. Two cam pegs 17 project inwardly from inner faces of the side walls 12. Each side wall 12 is provided with a guide slot 14 which extends from near a front of the side wall 12 towards a rear of the side wall 12. Each guide slot 14 comprises a mid section which forms a generally linear portion 20. The linear portion 20 runs at an angle of approximately 10° to the horizontal so as to be rearwardly inclined. A front end portion 21 of each guide slot 14 is downwardly inclined at an angle of approximately 45° such that the linear portion 20 and front end portion 21 together form a generally ‘V’-shaped slot with the apex of the V uppermost. A rear end portion 22 of each guide slot 14 comprises a relatively short, generally upwardly vertically directed perpendicular extension.

A raised lobe 15 is formed on the upper edge of each side wall 12 and comprising therein a clamp pivot hole 16.

The piercer unit 6 comprises an upwardly directed inlet piercer 16 and an upwardly directed outlet piercer 61 which are connected to a base 62. The base 62 is coupled in the aperture 13 of the base 10 such that the inlet piercer 60 and outlet piercer 62 project upwardly from the upper face of the base 11 as shown in FIG. 5.

The tray 3 comprises a body 30 which is generally rectangular and which is provided with two rearwardly extending arms 31. Each arm 31 is provided with a front guide peg 37 and a rear guide peg 38 both of which project outwardly from a side wall face of the arm 31. The body 30 defines a recess 32 for receiving in use a beverage cartridge 7 as shown in FIG. 6. The recess 32 is shaped to securely receive the beverage cartridge 7. An inlet piercer aperture 33, an outlet piercer aperture 34 and a barcode aperture 35 are provided in the recess 32 so as to be aligned with the inlet piercer 60, outlet piercer 61 and a barcode 104 which is provided on the beverage cartridge as shown for example in FIG. 10. If desired the base of the recess 32 may be provided with one or more upstanding projections which contact and deform a laminate face of the beverage cartridge 7 on clamping. The body 30 comprises a raised front lip 36. The upper surface of the generally horizontally extending arms 31 define a cam surface 39, the use of which will be described further below.

The clamp 4 comprises an outer member 40 and an inner member 41 which can be coupled and retained together by means of outwardly extending projections formed on the outer face of the inner member 41 which engage in catch members on the inner face of the outer member 40. The outer member 40 comprises a generally circular body having two rearwardly and upwardly extending arms 42. An outwardly projecting frame pivot peg 43 is provided at the distal end of each arm 42. An underside face of the arms 42 form a follower surface 47 the use of which will be described further below.

As most clearly shown in FIGS. 9a and 9b, the inner member 41 comprises a central inwardly directed projection 46 which is used to contact and clamp a central section of a beverage cartridge 7 in use as will be described further below. In addition, the inner member 41 comprises an inlet clamping zone 45 which serves to apply clamping force to an inlet zone of the beverage cartridge 7 as will be described further below.

The outer member 40 is further provided with two outwardly extending actuator pillar pegs 44 one on each side of the circular body.

The actuator 5 comprises a pair of actuator members each of which comprises a lobe-shaped body 50 and an upwardly extending actuator arm 51. A clamp pivot aperture 52 is provided in each lobe-shaped body 50. Beneath the clamp pivot aperture 52 is provided a cam slot 53. The cam slot 53 is arcuate and extends from an open end 54 to a closed end 55. The distance between the cam slot 53 and the clamp pivot aperture 52 decreases as one travels along the cam slot 53 from the open end 54 to the closed end 55. If desired the distal ends of the actuator arms 51 may be joined together by a connecting rod to form a handle by which the arms 51 can be moved in unison. Alternatively, the arms 51 may be mechanically linked to a motive driver element such as a motor.

FIG. 2 illustrates the clamping mechanism in an assembled configuration with no beverage cartridge present. As shown, the clamp 4 is in a clamped (i.e. closed) position and the tray 3 is in a brewing position in which the body 30 of the tray is parallel and in contact with the base 11 of the frame 2.

It will be noted that as assembled, each actuator member is coupled to the outer member 40 of the clamp 4 by inserting the actuator pivot pegs 44 through the clamp pivot apertures 52. Thus, the actuator pivot pegs 44 and clamp pivot apertures 52 form an actuator pivot 44/52.

The frame pivot pegs 43 of the outer member 40 are engaged in the clamp pivot apertures 16 of the side walls 12 of the frame 2. Thus, the frame pivot pegs 43 and the clamp pivot apertures 16 form a clamp pivot 16/43.

The tray 3 is slidingly coupled to the frame 2 such that the front guide pegs 37 and rear guide pegs 38 are slidingly received in the guide slots 14 of the side walls 12. In the position shown in FIG. 2, the rear guide pegs 38 are located at the rear of the guide slots 14 and upwardly located into the upwardly extending rear end portions 22 of the guide slots 14. The actuator arms 51 are pivoted forwards about the actuator pivot 44/52 such that the cam pegs 17 of the frame 2 are engaged in the cam slots 53 of the actuator arms 51 and located at the closed end 55 of each slot 53.

Operation of the clamping mechanism 1 will now be described starting from the position shown in FIG. 2.

In a first step as shown in FIG. 3, the actuator arms 51 are rotated rearwardly about actuator pivot 44/52 so as to move the cam pegs 17 relative to the cam slots 53. This causes the clamp 4 to pivot upwardly relative to the frame 2 about the clamp pivot 16/43 into an unclamped position. The rotational travel of the actuator arms 51 is approximately 90° about the actuator pivot 44/52. At this point, the cam pegs 17 are located near the open end 54 of the cam slots 53. In addition, at this point in operation the tray 3 has not moved from its brewing position.

In the next step, a user of the clamping mechanism lifts up on the front lip 36 of the tray 3 causing the tray 3 to pivot about the front guide pegs 37 causing the rear guide pegs 38 to descend along the rear end portions 22 of the actuator slots 14 to enter the end of the linear portion 20. Thus, the tray 3 is moved into an intermediate position.

In the next step, a user pulls on the tray 3 causing the tray 3 to slide forwards relative to the frame 2 such that the front guide pegs 37 and rear guide pegs 38 slide along the guide slots 14. The front guide pegs 37 slide along the linear portion 20 over the apex of the guide slot 14 and down the downwardly angled front end portion 21 to reach the position shown in FIG. 5 in which the front guide pegs 37 have abutted against a front-most end of the guide slots 14. As shown, at this point the rear guide pegs 38 are located at or near the apex of the guide slot 14. Thus, this causes the tray 3 to be declined forwardly so as to clearly proffer the recess 32 of the tray 3 to a user standing in front of the clamping mechanism. This is the loading position of the tray 3.

Movement of the tray 3 from the intermediate position of FIG. 4 to the loading position of FIG. 5 also causes the clamp 40 to be pivotally raised upwardly beyond the unclamped position so as to increase the clearance between the lower rim of the clamp 4 and the tray 3. This is caused by sliding contact between the cam surface 39 of the arms 31 of the tray 3 and the follower surfaces 47 of the arms 42 of the clamp 4. As can be most clearly seen from FIGS. 4 and 5, as the arms 31 of the tray 3 move forwards, the cam surface 39 first contacts the underside follower surface 47 of the arms 42. Further forward movement of the tray 3 causes the clamp 4 to be pivoted upwards in order to accommodate movement of the arms 31 beneath the arms 42. As can be seen in FIG. 5, in the loading position the clamp 4 comes to rest against the upper corners of the distal ends of the arms 31 of the tray 3.

In the next step as shown in FIG. 6, a user inserts the beverage cartridge 7 into the recess 32 with a laminate side of the cartridge facing downwards.

The process is then reversed in order to complete loading of the beverage cartridge 7. First as shown in FIG. 7, the tray 3 is pushed back into the frame 7 causing the front guide pegs 37 and rear guide pegs 38 to slide back along the guide slots 14 until the tray reaches its intermediate position. This movement also causes the cam surface 39 of the tray 3 to move clear of the follower surface 47 of the clamp 4 allowing the clamp 4 to drop back under gravity into its unclamped position. In this position as shown in FIG. 7, the beverage cartridge 7 is still unpierced since the tray 3 and clamp 4 are angled so as to still lie above the inlet piercer 60 and outlet piercer 61.

In the next step, the user presses down on the front lip 36 of the tray causing the tray to pivot downwardly about front guide pegs 37 such that the tray 3 moves back into the position of FIG. 2 where the tray lies parallel and in close contact with the base 11 of the frame 2. This pivoting of the tray 3 causes the rear guide pegs 38 to move back upwardly into the rear end portions 22 of the guide slots 14 locking the tray 3 in position and preventing forward movement of the tray 3. In this position the clamp 4 is still in the unclamped position and while the inlet piercer 60 and outlet piercer 61 now project upwardly through the inlet piercer aperture 33 and outlet piercer aperture 34, they will not yet pierce the laminate of the beverage cartridge 7 as the beverage cartridge 7 is free to be lifted up by the inlet piercer 16 and outlet piercer 61 so as to rest on top of the piercers.

It is only when the actuator arms 51 are rotated forwards as shown in FIG. 8 that the outer member 40 and inner member 41 of the clamp 4 are rotated downwardly as the fixed cam pegs 17 move along the cam slots 53 of the actuator 5. This downward rotation of the clamp 4 (including the inner member 41 as shown in FIGS. 9a and 9b) causes the inward central projection 46 to contact the recess 74 in the outer member 70 of the beverage cartridge and the inlet clamping zone 45 to contact above the inlet chamber 73 of the beverage cartridge which pushes down on the cartridge 7 causing the inlet piercer 60 and outlet piercer 61 to pierce the laminate and also to firmly clamp the beverage cartridge 7 against the tray 3. Preferably, the pivotal movement of the clamp between unclamped and clamped positions causes the inlet aperture and outlet aperture to be pierced sequentially in the beverage cartridge 7 with the inlet aperture being formed first. As shown in FIG. 5, the inlet piercer 60 and inlet piercer aperture 33 are located closer to the axis of the clamp pivot 16/43 than the location of the outlet piercer 61 and outlet piercer aperture 34.

Typically, the clamping mechanism 1 will form a part of a beverage preparation machine 300 as shown schematically in FIG. 22. Once the beverage cartridge 7 is loaded as described above operation of the beverage preparation machine may take place as known in the art, for example from EP 1 440 910 to dispense a beverage from the beverage cartridge into a suitable receptacle 301. The barcode aperture 35 in the tray 3 allows a barcode reader of the beverage preparation machine 300 to view a barcode on the laminate side of the beverage cartridge 7.

To remove the beverage cartridge 7 from the clamping mechanism 1, the operations described above are reversed in order to move the tray 3 from its brewing position through its intermediate position back to the loading position where the used beverage cartridge 7 may be removed and a new beverage cartridge 7 inserted if desired. Typically, the beverage cartridge 7 is dispensed at a pressure above atmospheric. On unclamping the beverage cartridge 7 by rotating the actuator arms 51 the built-up pressure starts to be vented. If necessary venting continues as the tray 3 is moved through the intermediate position and is slid relative to the frame 2. This ensures that by the time the tray 3 has reached the loading position the beverage cartridge 7 has fully vented and is thus ready to be unloaded.

The following description provides one example of a cartridge 7 which may be used with the clamping mechanism 1 and in the system of the present disclosure. While this exemplar cartridge 7 is provided with an entrainer, for incorporating air into the beverage, other cartridges may not have such an entrainer. Other exemplar cartridges which may be used include those commercially available from Kraft Foods, Inc under the trade name Tassimo® T-Discs® examples of which are described more fully in EP 1 440 909 and GB 2 416 480.

The cartridge of FIGS. 10 to 21 generally comprises an outer member 102, an inner member 103 and a laminate 105. The outer member 102, inner member 103 and laminate 105 having a bar code 104 thereon are assembled to form the cartridge 7 which has an interior 106 for containing one or mote beverage ingredients, an inlet 107, an outlet 108 and a beverage flow path linking the inlet 107 to the outlet 108 and which passes through the interior 106. The inlet 107 and outlet 108 are initially sealed by the laminate 105 and are opened in use by piercing or cutting of the laminate 105.

The illustrated example of the cartridge 7 is particularly designed for use in dispensing espresso-style products such as roast and ground coffee where it is desirable to produce a crema.

As can be seen from FIG. 10, the overall shape of the cartridge 7 is generally circular or disc-shaped with the diameter of the cartridge 7 being significantly greater than its height. A major axis Y passes through the centre of the outer member as shown in FIG. 21. Typically the overall diameter of the outer member 102 is 74.5 mm±6 mm and the overall height is 16 mm±3 mm. Typically the volume of the cartridge 7 when assembled is 30.2 ml±20%.

The outer member 102 generally comprises a bowl-shaped shell 110 having a curved annular wall 113, a closed top 111 and an open bottom 112. The diameter of the outer member 102 is smaller at the top 111 compared to the diameter at the bottom 112, resulting from a flaring of the annular wall 113 as one traverses from the closed top 111 to the open bottom 112. The annular wall 113 and closed bottom 112 together define a receptacle having an interior 134.

A hollow inwardly directed cylindrical extension 118 is provided in the closed top 111 centred on the major axis X. As more clearly shown in FIG. 12, the cylindrical extension 18 comprises a stepped profile having first, second and third portions 219, 220 and 221. The first portion 219 is right circular cylindrical. The second portion 220 is frusto-conical in shape and is inwardly tapered. The third portion 221 is another right circular cylinder and is closed off by a lower face 131. The diameter of the first, second and third portion 219, 220 and 221 incrementally decreases such that the diameter of the cylindrical extension 118 decreases as one traverses from the top 111 to the closed lower face 131 of the cylindrical extension 118. A generally horizontal shoulder 132 is formed on the cylindrical extension 118 at the junction between the second and third portions 220 and 221.

An outwardly extending shoulder 133 is formed in the outer member 102 towards the bottom 112. The outwardly extending shoulder 133 forms a secondary wall 115 co-axial with the annular wall 113 so as to define an annular track forming a manifold 116 between the secondary wall 115 and the annular wall 113. The manifold 116 passes around the circumference of the outer member 102. A series of slots 117 are provided in the annular wall 113 level with the manifold 116 to provide gas and liquid communication between the manifold 116 and the interior 134 of the outer member 102. As shown in FIG. 11, the slots 117 comprise vertical slits in the annular wall 113. Between twenty and forty slots are provided. In the embodiment shown thirty-seven slots 117 are provided generally equi-spaced around the circumference of the manifold 16. The slots 117 are preferably between 1.4 and 1.8 mm in length. Typically the length of each slot 117 is 1.6 mm representing 10% of the overall height of the outer member 102. The width of each slot 117 is between 0.25 and 0.35 mm. Typically, the width of each slot 117 is 0.3 mm. The width of the slots 117 is sufficiently narrow to prevent the beverage ingredients passing there through into the manifold 116 either during storage or in use.

An inlet chamber 126 is formed in the outer member 102 at the periphery of the outer member 102. A cylindrical wall 127 is provided, as most clearly shown in FIG. 11, which defines the inlet chamber 126 within, and partitions the inlet chamber 126 from, the interior 134 of the outer member 102. The cylindrical wall 127 has a closed upper face 128 which is formed on a plane perpendicular to the major axis Y and an open lower end 129 co-planar with the bottom 12 of the outer member 102. The inlet chamber 26 communicates with the manifold 116 via two slots 230 as shown in FIG. 11. Alternatively, between one and four slots may be used to communicate between the manifold 116 and the inlet chamber 126.

A lower end of the outwardly extending shoulder 133 is provided with an outwardly extending flange 135 which extends perpendicularly to the major axis Y. Typically the flange 135 has a width of between 2 and 4 mm. A portion of the flange 135 is enlarged to form a handle 124 by which the outer member 102 may be held. The handle 124 is provided with an upturned rim 225 to improve grip.

The outer member 102 is formed as a single integral piece from high density polyethylene, polypropylene, polystyrene, polyester, or a laminate of two or more of these materials.

The inner member 103, as shown in FIGS. 17 to 20, comprises an annular frame 141 and a downwardly extending cylindrical funnel 140. A major axis Y passes through the centre of the inner member 103 as shown in FIG. 17.

As best shown in FIGS. 18 and 19, the annular frame 141 comprises an outer rim 151 and an inner hub 152 joined by ten equi-spaced radial spokes 153. The inner hub 152 is integral with and extends from the cylindrical funnel 140. Filtration apertures 155 are formed in the annular frame 141 between the radial spokes 153. A filter 104 is disposed on the annular frame 141 so as to cover the filtration apertures 155. The filter is preferably made from a material with a high wet strength, for example a non-woven fibre material of polyester. Other materials which may be used include a water-impermeable cellulosic material, such as a cellulosic material comprising woven paper fibres. The woven paper fibres may be admixed with fibres of polypropylene, polyvinyl chloride and/or polyethylene.

As shown in the cross-sectional profile of FIG. 17, the inner hub 152 is located at a lower position than the outer rim 151, resulting in the annular frame 141 having a sloping lower profile.

The upper surface of each spoke 153 is provided with an upstanding web 154 which divides a void space above the annular frame 141 into a plurality of passages 157. Each passage 157 is bounded on either side by a web 154 and on a lower face by the filter 104. The passages 157 extend from the outer rim 151 downwardly towards, and open into, the cylindrical funnel 140 at openings 156 defined by the inner extremities of the webs 154.

The cylindrical funnel 140 comprises an outer tube 142 surrounding an inner discharge spout 143. The outer tube 142 forms the exterior of the cylindrical funnel 140. The discharge spout 143 is joined to the outer tube 142 at an upper end of the discharge spout 143 by means of an annular flange 147. The discharge spout 143 comprises an inlet 145 at an upper end which communicates with the openings 156 of the passages 157 and an outlet 144 at a lower end through which the prepared beverage is discharged into a cup or other receptacle. The profile of the discharge spout 43 comprises a stepped profile with a distinct dog-leg 166 near an upper end of the tube 143.

As shown in FIG. 17, the discharge spout 143 is provided with a partition 165 which extends part way up the discharge spout 143 from the outlet 144. The partition 165 helps to prevent the beverage spraying and/or splashing as it exits the discharge spout 143.

A rim 167 is provided upstanding from the annular flange 147 joining the outer tube 142 to the discharge spout 143. The rim 167 surrounds the inlet 145 to the discharge spout 143 and defines an annular channel 169 between the rim 167 and the upper portion of the outer tube 142. The rim 167 is provided with an inwardly directed shoulder 168. At one point around the circumference of the rim 167 an aperture 170 is provided in the form of a slot which extends from an upper edge of rim 167 to a point marginally below the level of the shoulder 168 as most clearly shown in FIGS. 17 and 17a. The slot has a width of 0.64 mm.

An air inlet 171 is provided in annular flange 147 circumferentially aligned with the aperture 170 as shown in FIGS. 17 and 17a. The air inlet 171 comprises an aperture passing through the flange 147 so as to provide communication between a point above the flange 147 and the void space below the flange 147 between the outer tube 142 and discharge spout 143. Preferably, and as shown, the air inlet 171 comprises an upper frusto-conical portion 173 and a lower cylindrical portion 172. The air inlet 171 is typically formed by a mould tool such as a pin. The tapered profile of the air inlet 171 allows the mould tool to be more easily removed from the moulded component. The wall of the outer tube 142 in the vicinity of the air inlet 171 is shaped to form a chute leading from the air inlet 171 to the inlet 145 of the discharge spout 143. As shown in FIG. 17a, a canted shoulder 174 is formed between the air inlet 171 and the chute to ensure that the jet of beverage issuing from the slot 170 does not immediately foul on the upper surface of the flange 147 in the immediate vicinity of the air inlet 171.

The inner member 103 may be formed as a single integral piece from polypropylene or a similar material as described above.

The laminate 105 is formed from two layers, a first layer of aluminium and a second layer of cast polypropylene. The aluminium layer is between 0.02 and 0.07 mm in thickness. The cast polypropylene layer is between 0.025 and 0.065 mm in thickness. In one embodiment the aluminium layer is 0.06 mm and the polypropylene layer is 0.025 mm thick. This laminate 105 is particularly advantageous as it has a high resistance to curling during assembly. As a result the laminate 105 may be pre-cut to the correct size and shape and subsequently transferred to the assembly station on the production line without undergoing distortion. Consequently, the laminate 108 is particularly well suited to welding. Other laminate materials may be used including PET/Aluminium/PP, PE/EVOH/PP, PET/metallised/PP and Aluminium/PP laminates. Roll laminate stock may be used instead of die cut stock.

The cartridge 7 may be closed by a rigid or semi-rigid lid instead of a flexible laminate 105.

Assembly of the cartridge 7 is as described in EP 1 440 909 and EP 1 796 516.

In use water, under pressure, enters the cartridge 7 through the inlet 107 into the inlet chamber 126. From there the water is directed to flow through the slots 117 and round the manifold 116 and into the filtration chamber 160 of the cartridge 1 through the plurality of slots 117. The water is forced radially inwardly through the filtration chamber 160 and mixes with the beverage ingredients 200 contained therein. The water is at the same time forced upwardly through the beverage ingredients 200. The beverage formed by passage of the water through the beverage ingredients 200 passes through the filter 104 and filtration apertures 155 into the passages 157 lying above the annular frame 141.

Beverage in the radial passages 157 flows downwardly along the passages 157 formed between the webs 154 and through the openings 156 and into the annular channel 169 of the cylindrical funnel 140. From the annular channel 169 the beverage is forced under pressure through the aperture 128 by the back pressure of beverage collecting in the filtration chamber 160 and passages 157. The beverage is thus forced through aperture as a jet and into an expansion chamber formed by the upper end of the discharge spout 143. As shown in FIG. 21, the jet of beverage passes directly over the air inlet 171. Passage of the beverage through the restriction of the aperture causes the pressure of the beverage to be reduced. As the beverage enters the discharge spout 143 the pressure of the beverage is still relatively low. As a result air is entrained into the beverage stream in the form of a multitude of small air bubbles as air from an exterior of the cartridge 7 is drawn up through the air inlet 171. The jet of beverage issuing from the aperture is funnelled downwards to the outlet 144 where the beverage is discharged into the outlet tube 120 described above and from there on into a receptacle such as a cup where the air bubbles form the desired crema. Thus, the aperture and the air inlet 171 together form an air entrainer which acts to entrain air into the beverage.

1. A clamping mechanism for a beverage cartridge comprising:
a frame;
a tray suitable for receiving a beverage cartridge therein;
a clamp; and
an actuator;
wherein the tray is coupled to the frame to allow the tray to move between a brewing position and a loading position;
wherein the actuator is pivotably connected to the clamp and the clamp is pivotably connected to the frame to allow the clamp to be pivoted between a clamped position and an unclamped position on rotation of the actuator relative to the frame;
wherein the tray is engagable with the clamp during movement of the tray into the loading position to move the clamp from the unclamped position to a raised position.

2. The clamping mechanism of claim 1 wherein the tray is slidably movable between the loading position and an intermediate position and further pivotably movable from the intermediate position into the brewing position.

3. The clamping mechanism of claim 2 wherein the tray is manually slidably movable between the loading position and the intermediate position.

4. The clamping mechanism of claim 2 wherein the tray is manually movable from the intermediate position into the brewing position by pressing down on a front of the tray.

5. The clamping mechanism of claim 1 wherein the tray is slidably coupled to the frame.

6. The clamping mechanism of claim 5 wherein the frame comprises a pair of guide slots and the tray comprises first and second pairs of guide pegs slidably received in the guide slots.

7. The clamping mechanism of claim 2 wherein the tray is slidably coupled to the frame, the frame comprises a pair of guide slots, and the tray comprises first and second pairs of guide pegs slidably received in the guide slots, and wherein the first and second pairs of guide pegs are slidable along the pair of guide slots during movement of the tray between the loading position and the intermediate position and wherein the tray is pivotably movable about the first pair of guide pegs during movement of the tray between the intermediate position and the brewing position.

8. The clamping mechanism of claim 6 wherein each guide slot comprises a substantially linear portion and a downwardly-angled end portion such that on movement of the tray into the loading position at least one of the first and second pairs of guide pegs enters the downwardly-angled end portion to enable the tray to be declined to facilitate access to a beverage cartridge received therein.

9. The clamping mechanism of claim 1 wherein the actuator comprises a cam slot and the frame comprises a fixed cam peg the cam peg being engagable in the cam slot̂ to move along said cam slot on rotation of the actuator. 10. The clamping mechanism of any preceding claim wherein a portion of the tray defines a cam surface and a portion of the clamp defines a follower surface, such that on movement of the tray into the loading position relative sliding contact between the cam surface and the follower surface enables the clamp to be rotated into the raised position.

10. The clamping mechanism of claim 1 wherein a portion of the tray defines a cam surface and a portion of the clamp defines a follower surface, such that on movement of the tray into the loading position relative sliding contact between the cam surface and the follower surface enables the clamp to be rotated into the raised position.

11. The clamping mechanism of claim 10 wherein the tray comprises a body defining a receptacle for receiving a beverage cartridge and a pair of arms; wherein the clamp comprises a body and a pair of arms; wherein an upper surface of the arms of the tray define the cam surface and a lower surface of the arms of the clamp define the follower surface.

12. The clamping mechanism of claim 1 further comprising an inlet piercer and/or outlet piercer for forming an inlet and/or outlet in a beverage cartridge received within the tray.

13. A beverage preparation system comprising a beverage preparation machine and a beverage cartridge, wherein the beverage preparation machine comprises a clamping mechanism as claimed in claim 1.

14. The beverage preparation system of claim 13 wherein the beverage cartridge comprises a cup-shaped body and a substantially planar lid sealing the cup-shaped body, the beverage cartridge containing one or more beverage ingredients, wherein the beverage cartridge is shaped to be received in the tray of the clamping mechanism with the lid lowermost, rotation of the clamp into the clamped position being effective to pierce the lid.

15. A method of clamping a beverage cartridge in a clamping mechanism of the type comprising a frame, a tray, a clamp and an actuator; comprising the steps of
a) moving the tray outwards relative to the frame into a loading position causing simultaneously the clamp to be pivoted into a raised position;
b) inserting the beverage cartridge into the tray;
c) manually sliding the tray inwards relative to the frame simultaneously causing the clamp to pivot downwards into an unclamped position;
d) rotating the actuator to move the clamp into a clamped position in which the beverage cartridge is clamped ready for brewing.

16. The method of claim 15 comprising between steps c) and d) the step of manually pivoting the tray relative to the frame to move the tray into a brewing position.

17. (canceled)
